(19) United States
(12) Patent Application Publication
(10) Pub. No.: US 2009/0218538 A1
(43) Pub. Date: Sep. 3, 2009

(54) Nano-scale self assembly in spinels induced by Jahn-Teller distortion

(75) Inventors: Sang-Wook Cheong, Highland Park, NJ (US); Yeo Sunmog, Phang (KR)

Correspondence Address: DUANE MORRIS LLP - Princeton, PO BOX 5203, PRINCETON, NJ, 08543-5203, US

(73) Assignee: Rutgers, The State University, New Brunswick, NJ (US)

(21) Appl. No.: 11/916,362

(22) PCT Filed: Jun. 5, 2006
(86) PCT No.: PCT/US06/21813

§ 371 Date: Jun. 19, 2008

Related U.S. Application Data
(60) Provisional application No. 60/686,949, filed on Jun. 3, 2005.

(51) Int. Cl. H01F 1/01

(52) U.S. Cl. 252/62.51 R

(57) ABSTRACT

A method for making a self-assembled spinel having an ordered nanocrystal superlattice. The method may involve the steps of providing an oxide mixture that is capable of forming a spinel having Jahn-Teller ions; sintering or heat-treating the mixture to form the spinel having the Jahn-Teller ions; and cooling the spinel having the Jahn-Teller ions at a rate of less than 400° C./hour. Also, a nano-scale spinel formed by self-assembly. The nano-scale spinel may include a first phase of spinel comprising a high concentration of Jahn-Teller ions; and a second phase of spinel including a low concentration of Jahn-Teller ions. Further, a high density storage device including a nano-scale spinel formed by self-assembly, the nano-scale spinel including a first phase of spinel comprising a high concentration of Jahn-Teller ions; and a second phase of spinel including a low concentration of Jahn-Teller ions.

### CROSS-REFERENCE TO RELATED APPLICATIONS

This application claims the benefit of U.S. Provisional Application Ser. No. 60/686,949, filed on Jun. 3, 2005, the entire disclosure of which is incorporated herein by reference.

### FIELD OF THE INVENTION

The invention relates to articles made from nanoscale self assembled materials, which do not use any organic materials.

### BACKGROUND OF THE INVENTION

The process by which components spontaneously form ordered aggregates is called self-assembly. The components may be of various scales ranging from molecular to planetary scales.

Recently, there has been an interest in applying the principles of self-assembly to nano-technology because it is believed that self-assembly is one of the most general strategies for generating nano-structures. Self-assembly carries out many of the most difficult steps in nanofabrication.

Presently, most of periodic structures with nanocrystals or nano-structural units are fabricated using self-assembly by mediating various organic materials. Thus, synthesized nanocrystals are coated by organic materials which may affect the properties of nanocrystals. In addition, using organic media tends to complicate the process of nano-structured materials. In general, structures with nanocrystals or nano-structural units prepared by means of inorganic processes tend to be poorly ordered or the relevant size tends to be large.

Tremendous efforts have been performed in order to make nanoparticles with controlled size and composition. The synthesis of nanoparticles utilizes various chemicals including, but not limited to, polymers, dendrimers, micells, and capillary materials.

Accordingly, a method is needed for periodic self-assembly of nanocrystals and nano-structured materials without the use of organic materials.

### SUMMARY OF INVENTION

A method is disclosed for making a self-assembled spinel having an ordered nanocrystal superlattice. In one embodiment, the method may comprise the steps of providing an oxide mixture that is capable of forming a spinel having Jahn-Teller ions; sintering or heat-treating the mixture to form the spinel having the Jahn-Teller ions; and cooling the spinel having the Jahn-Teller ions at a rate of less than 400° C./hour.

Also disclosed is a nano-scale spinel formed by self-assembly. In one embodiment, the nano-scale spinel may comprise a first phase of spinel comprising a high concentration of Jahn-Teller ions; and a second phase of spinel comprising a low concentration of Jahn-Teller ions.

Further disclosed is a high density storage device comprising a nano-scale spinel formed by self-assembly, the nano-scale spinel comprising a first phase of spinel comprising a high concentration of Jahn-Teller ions; and a second phase of spinel comprising a low concentration of Jahn-Teller ions.

### BRIEF DESCRIPTION OF THE DRAWINGS

FIGS. 1a-1c are TEM images for 5° C./hour cooled ZnMnGaO₄ at room temperature.

FIGS. 2a-2c are TEM images for a checkerboard pattern at room temperature.

FIG. 3a show x-ray diffraction patterns for x=0.5 1.0 and 1.7 with different cooling rates.

FIG. 3b is a phase diagram of ZnMnₓGa₂₋ₓO₄.

FIG. 4a is a schematic view of the checkerboard domain.

FIG. 4b shows magnetic susceptibility data with different cooling rates for Co_{1.5}Mn_{1.5}O₄.

FIG. 5 is a flowchart depicting an embodiment of a method of making a self-assembled article or structure having an ordered nanocrystal superlattice.

### DETAILED DESCRIPTION OF THE INVENTION

The Jahn-Teller (JT) effect is a phenomenon where lattices are distorted by lifting or removing orbital degeneracy of transition-metal ions. The transition-metal ions generating the JT effect are commonly known as JT ions. For example, in an oxide spinel system whose chemical formula is AB₂O₄ where A and B represent every atom that is capable of forming the spinel oxide system, when the B site is occupied by Jahn-Teller ions, such as Mn ions or Cu ions, their octahedral cages are deformed by removing their orbital degeneracy.

As disclosed herein, JT ions are substituted for other ions in spinel and other systems, at certain doping concentrations, which causes the system to separate into two regions or phases: a JT ion rich region or phase and a JT ion poor region or phase. The microscopic structure induced by the phase separation “self-assembles” an ordered nanocrystal superlattice. For example, in one embodiment comprising a spinel (Co,Mn,Fe)₃O₄ system, the phase separation self-assembles a nano-scale square bar array having alternating magnetic and nonmagnetic bars, at room temperature.

The above array may be used, for example, as high density magnetic storage media. Current hard disk technology allows for the fabrication of about 40 gigabytes per square inch of storage density. The nano-scale bar arrays disclosed herein may be capable of more than 10 terabytes per square inch of storage density. Because the storage density is greater than what is currently available, smaller and lighter hard disks may be fabricated using the nano-scale bar arrays disclosed herein.

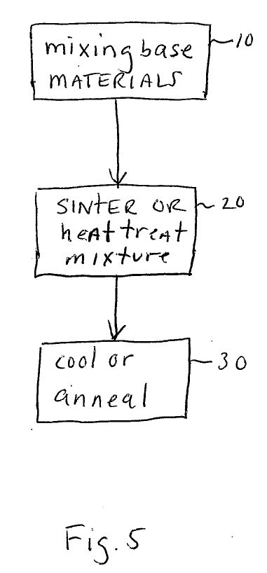

FIG. 5 is a flowchart of an embodiment of a method of making a self-assembled article or structure having an ordered nanocrystal superlattice. The method is does not use any organic materials. Step 10 of the method comprises mixing, blending or otherwise combining two or more inorganic materials together which are capable of forming a material having JT ions. Step 20 of the method comprises sintering or heat-treating the mixture formed in step 10 to form the material having the JT ions. Step 30 of the method comprises cooling the material at a rate of less than 400° C./hour. In alternate embodiments, the cooling step 30 may be replaced by annealing at a temperature below about 600° C. for more than one hour.

The inorganic materials used in the method may be in any suitable form including, but not limited to, powder form, small or large crystal form, and film form. The inorganic materials may be mixed or blended together using any suitable manual or automatic mixing or blending method including, but not limited to, hand-grinding in a mortar and pestle and ball milling. In some embodiments, stoichiometric amounts of the inorganic materials provided in powder form may be manually mixed or blended together by hand-grinding the powders in a mortar and pestle for between about 10 and about 60 minutes.

The inorganic materials used in the method comprise, but are not limited to, spinel-type oxides. Examples of suitable spinel-type oxides may include, but are not limited to, zinc oxides such as ZnO, manganese oxides such as Mn₂O₃ and MnO₂, gallium oxides such as Ga₂O₃, magnesium oxides such as MgO, cobalt oxides such as Co₃O₄, iron oxides such as Fe₂O₃, and copper oxides such CuO. Of these spinel-type oxides, the manganese oxides supply the magnetic ions which generate the JT effect.

In one embodiment, the oxides mixed in step 10 may comprise three spinel-type oxides: ZnO, Mn₂O₃, and Ga₂O₃, which form ZnMnₓGa₂₋ₓO₄ depending upon the quantity of each of the oxides in the mixture. In other embodiments, the oxides mixed in step 10 may comprise four spinel-type oxides: MgO, Co₃O₄, Fe₂O₃ and Mn₂O₃, which form MgMnₓFe₂₋ₓO₄ and/or Co_{3-x-y}MnₓFe_{y}O₄, depending upon the quantity of each of these oxides in the mixture. In these systems, the slow-cooling or annealing steps of the method induces a phase separation comprising a first phase with a relative small quantity of Mn ions and a second phase having a relatively larger quantity of Mn ions. Thus, the first phase has a substantially quantity of Fe ions, so that it becomes magnetic (ferrimagnetic). In this way, the magnetic first phase is surrounded by a slightly- or non-magnetic second phase in nano-scale, so that the overall structure can be used for nano-technology.

The JT systems display a variety of physics such as structural phase transition, anomalous magnetoresistance and high temperature superconductivity. The present method utilizes the phase separation caused by JT effect in spinel and other systems to achieve a self-assembled nanocrystal superlattice. The substitution of non JT ions for JT ions may lead to a phase separation with a higher and lower concentration of JT ions. In other words, JT ions tend to gather each other through the JT transition. This phase separation is known in the art as the spinodal decomposition. The random crystal fields by the substitution reduce the structural transition temperature and affect the position of the boundaries of immiscibility regions. Though the existence of the miscibility gap in spinel systems is known, systematic studies in the immiscibility regions are not many.

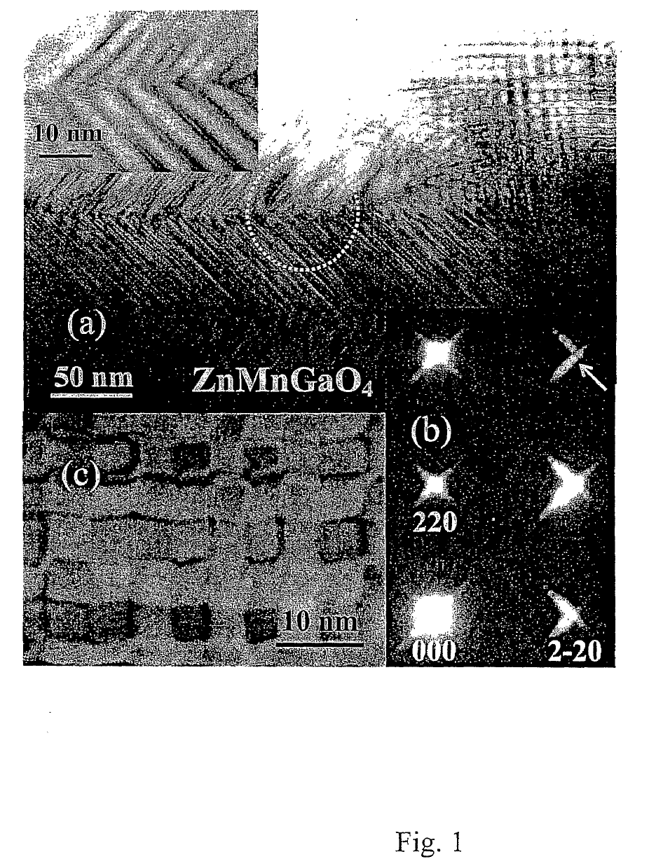

Samples of ZnMnGaO₄ made in accordance with the methods disclosed herein were examined using transmission electron microscope (TEM) techniques. The samples were prepared using the above method by mixing together stoichiometric amounts of ZnO, Mn₂O₃ and Ga₂O₃, sintering the mixture at temperature of at 1150° C. and cooling the resulting ZnMnGaO₄ at a rate of about 5° C./hour. FIGS. 1a-1c are TEM images which show bright-field images and an electron diffraction pattern at room temperature of the ZnMnGaO₄ samples. The electron beam was parallel to the [001] direction and indices of the cubic spinel structure were used for diffraction spots. Systems that have tetragonal twin boundaries often display a herringbone structure such as, La₂CuO_{4+δ}. The herringbone structure shown in FIG. 1a, however, may be differentiated from other herringbone structures by size. In addition, the image shown in FIG. 1a displays the coexistence of herringbone and checkerboard domains in the same ZnMnGaO₄ sample. It is known that the tetragonal twin usually produces three different domains in a cross-sectional view. In FIG. 1a, the three domains comprise the two herringbone domains and the one checkerboard domain. A cross section of a fringe in the herringbone domain corresponds to a square in the checkerboard domain. The magnified image denoted by the circle (the inset of FIG. 1a) shows the twin wall or boundary between two herringbone domains and the distance between black (or white) fringes is about 6 nm. When electrons pass through the specimen, the undistorted region transmits electrons more easily than the distorted region. Thus, the black fringes are believed to be distorted regions caused by the JT ion, Mn³⁺. In FIG. 1a, the twin wall between herringbone domains is sharp and clearly visible because the electron incidence direction is parallel to the wall. However, the twin wall between the herringbone and checkerboard domains is inclined to the electron incidence direction by about 45 degrees. Thus, the twin wall in FIG. 1a appears to be blurred due to averaging.

Referring now to the TEM image of FIG. 1b, the diffraction pattern of the herringbone domain clearly reveals diffuse streaks and split spots. The directions of the streaks are in the [110] direction or the [1-10] direction, which correspond to perpendicular directions of the fringes. Since the JT distortion elongates the c axis of the ZnMn₂O₄, the B site ions along the [110] direction or the [1-10] direction are closer to each other. This indicates that the gathering of the JT ions due to phase separation can easily occur along the [110] direction or the [1-10] direction rather than the other directions in this system and the c-axis is always parallel to the direction of the fringes in the herringbone domain. The periodic configuration of the fringes generates the superlattice peaks in the diffraction pattern. The arrow indicates the first (1^{st}) order superlattice peak at the (620) peak. The distance between (000) and (400) is about 28 times larger than that between the first order superlattice peak and the center of the (620) peak. The lattice constraints of ZnGa₂O₄ and the pseudocubic cell of ZnMn₂O₄ are 8.334 Å and 8.087 Å, respectively. The calculated lattice constant of the pseudocubic cell of ZnMnGaO₄ with Vegard's law indicates that the new structural modulation is about 6 nm. This result is consistent with the high resolution image on the herringbone domain. From FIG. 1c, it can be seen that the size of the square is about 4 nm. Thus, the size of diagonal of the square is about 6 nm, which corresponds to the distance between fringes in the herringbone domain. Moreover, from FIG. 1a, the direction of the fringes in the herringbone domain is same as the diagonal direction of the square in the checkerboard domain. This indicates that the shape of the nanocrystal is a long, square bar and the fringes in the herringbone domain are the longitudinal edges of square bars. In fact, the TEM certifies that the checkerboard domain exists by rotating the herringbone domain by 90 degrees. Since the distance between twin boundaries is about 60 nm, the size of square bar is about 4 nm×4 nm×85 nm. From above discussion, it should be apparent that the nanocrystal induced by JT ions has a highly anisotropic shape and the longitudinal direction of the square bar is along c-axis of the nanocrystals.

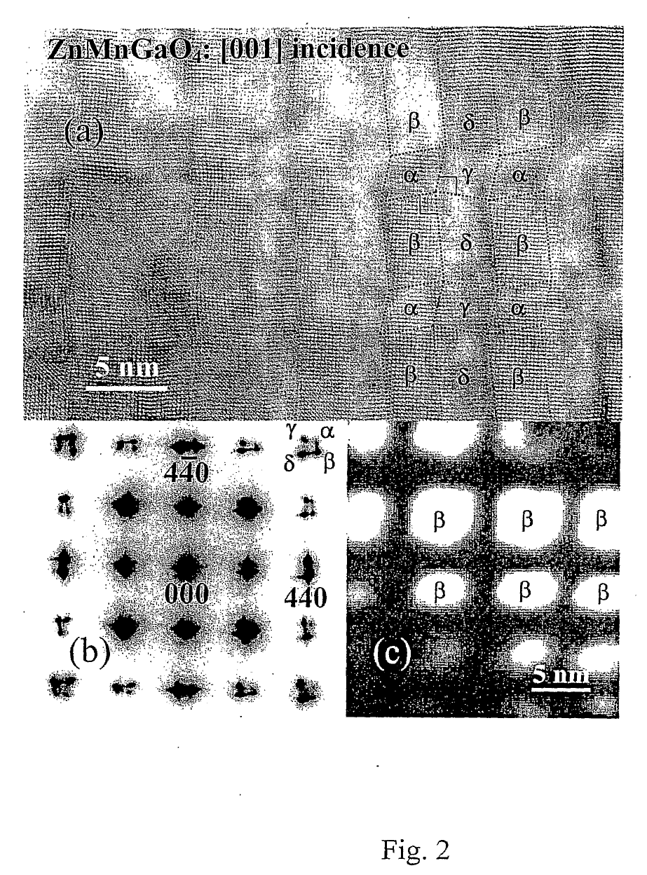

The TEM image of FIG. 2a is the high resolution image of the checkerboard domain shown in FIGS. 1a-1c, at room temperature. As can be seen, the checkerboard domain includes four different domains labeled α, β, γ, and δ. The β and γ domains are of a cubic structure while the α and δ domains are of an orthorhombic structure. The β and γ domains are rotated by 6 degrees counterclockwise and clockwise, respectively. The α and δ domains show distorted structures along the rotation of cubic domain, which is caused by the phase separation. It is known that the substitution of non JT ions for JT ions can give rise to a phase separation with a higher and lower concentration of JT ions. The TEM images reveal that the domain with the higher concentration of JT ions is more distorted so that the domain composes an orthorhombic structure. The superlattice peaks ((800) peak) represent the four different domains in the diffraction pattern of FIG. 2b. By controlling the position of the TEM aperture, the dark field (DF) image of the superlattice for the β domain is obtained at room temperature as shown in FIG. 2c. The DF image displays a square array.

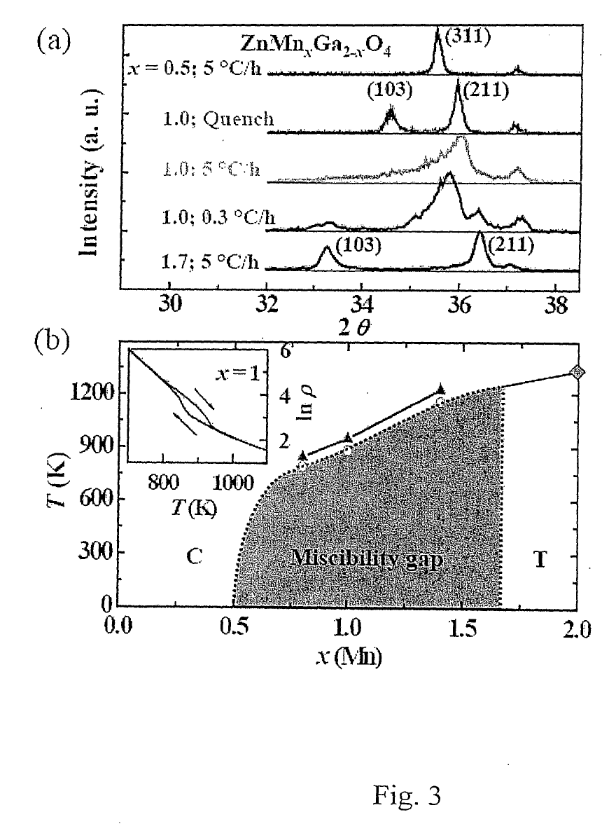

The x-ray diffraction results shown in FIGS. 3a and 3b clarify the phase separation of the ZnMnₓGa₂₋ₓO₄ system. For 0≦x≦0.5, the system maintains a cubic spinel structure (space group; Fd3m) with identified peaks. For 1.7≦x≦2, the ZnMnₓGa₂₋ₓO₄ system maintains a tetragonal spinel structure (space group; I4₁/amd) with sharp peaks for the 5° C./hour cooled ZnMn₂O₄ samples. In the miscibility gap region (0.5≦x≦1.7), however, the cooling rates highly affect the results of x-ray diffraction pattern. For example, the x-ray pattern of a quenched ZnMn₂O₄ sample for x=0.6 at 1150° C. represents the cubic structure, while the ZnMn₂O₄ sample cooled at 5° C./hour shows the tetragonal spinel structure. Furthermore, the x-ray patterns for x=1.0 dramatically change with different cooling rates. Even though the JT transition temperature of ZnMnGaO₄ is about 900°K, the quenched ZnMn₂O₄ sample at 1150° C. does show the tetragonal spinel structure. This indicates that the kinetics of cooperative JT effect is faster than the quenching speed. Then, the (311) peak of Fd3m splits into the (211) and (103) peaks of I4₁/amd. Interestingly, the x-ray pattern of the 5° C./hour cooled ZnMnGaO₄ sample displays substantial peak broadening. Compared to the (103) peak position of the quenched sample, that of 5° C./hour cooled sample shifts to a lower angle of about 1.5 degrees, which is quite close to that of x=1.7. This indicates that 5° C./hour cooled ZnMnGaO₄ sample already has some components of x=1.7 concentration. Since a 0.3° C./hour cooled ZnMnGaO₄ sample shows cubic and tetragonal structures at the same time, one can expect that the 5° C./hour cooled ZnMnGaO₄ sample has some development of the cubic phase, though the x-ray pattern does not show a clear cubic phase. In fact, the 5° C./hour cooled ZnMnGaO₄ sample has self assembled nanocrystals. Therefore, the peak broadening of the 5° C./hour cooled ZnMnGaO₄ sample originated from a small grain size effect and the development of the cubic phase. On the other hand, the x-ray pattern of the 0.3° C./hour cooled ZnMnGaO₄ sample simultaneously shows the peak of Fd3m and peaks of I4₁/amd, which confirm the phase separation. However, the 0.3° C./hour cooled ZnMnGaO₄ sample does not show a nanocrystal superlattice, but a micron order phase separation.

In order to obtain the JT transition temperature, high temperature resistivity measurements were performed on heating and cooling. The inset of FIG. 3b is an example of the resistivity measurement. The transition temperature was determined by the maximum temperature of dp/dT where p and T are resistivity and temperature, respectively. The closed triangles and circles are the transition temperature for heating and cooling, respectively. The transition temperatures systematically change with increasing Mn concentration. Based on x-ray and resistivity data, the phase diagram of ZnMnGa₂₋ₓO₄ is constructed as shown in FIG. 3b. The concentrations for the miscibility gap are determined by x-ray data of the 5° C./hour cooled ZnMn₂O₄ samples.

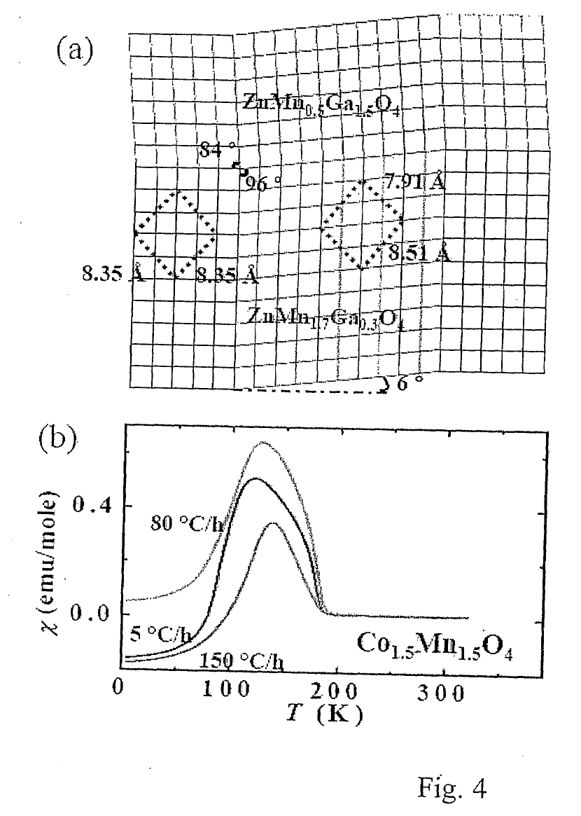

FIG. 4a is a schematic view of the checkerboard domain described above. The measured lattice constant of the cubic structure is about 835 Å, which is slightly larger than that of ZnGa₂O₄. When a system has a miscibility gap, the nominal concentration in the miscibility gap be separated into two concentrations; the high and low concentration ends of the miscibility gap. Therefore, the cubic domain and the distorted domain most likely include ZnMn_{0.5}Ga_{1.5}O₄ and ZnMn_{1.7}Ga_{0.3}O₄, respectively. Since two cubic domains are rotated clockwise and counterclockwise by six degrees, respectively, the distorted domain has an obtuse angle (96 degrees) and an acute angle (84 degrees). In order to determine the simplest structure of the distorted domain, the sides of the structure can be set as shown in FIG. 4a. Then, all the sides of the structure meet each other at right angles and the lengths of the sides are 7.91 Å and 8.51 Å and 8.35 Å, respectively. This means the structure of the distorted domain is orthorhombic.

In contrast to the ZnMnₓGA₂₋ₓO₄ system, there are many ferrimagnetic spinel systems, for example, the CoMn₂O₄ and MnCo₂O₄ systems, to name a few. The CoMn₂O₄ system is a conventional spinel with a tetragonal structure (space group; I4₁/amd)¹³ where Mn is a JT ion. Substitution of Co for the Mn site also reveals a similar nano-structure as shown in the inset of FIG. 4b. As with the ZnMnₓGA₂₋ₓO₄ system, proper cooling rates are required for obtaining nanocrystals. For example, the Co_{1.5}Mn_{1.5}O₄ system requires a cooling rate is about 80° C./hour to obtain nanocrystals. In addition, the proper cooling rates systematically changes with Mn ion concentration. The magnetic properties of nano square bars for the Co_{1.5}Mn_{1.5}O₄ system is quite peculiar. When ferromagnetic nanocrystals are formed in a system, the transition temperature (T_{c}) substantially reduces due to the superparamagnetic nature of nanocrystals. However, the nanocrystals of the Co_{1.5}Mn_{1.5}O₄ system does not show any reduction of T_{c}, which may be due to the highly anisotropic shape of the nanocrystal or strains, etc. In addition, it has been reported that the oriented single domain nanoparticles may be thermally stable down to 10 nm or even smaller. Therefore, thanks to the well oriented nature of this nanocrystal, the T_{c}, may not be changed.

As should now be apparent, the nanocrystals induced by JT ions have unique properties. For example, the nanocrystal superlattice may be formed without using any organic material. The shape of the nanocrystals is quite anisotropic (about 4 nm×4 nm×85 nm) so that anisotropy energy is large compared to other nanocrystals. The nanocrystals display well oriented superlattices. With these advantages, the nanocrystals induced by the JT ions are usable for the high density magnetic storage media. One major problem with increasing the areal density of magnetic storage media is the superparamagnetic limit due to thermal relaxation. However, the nanocrystals induced by JT ions are not affect by the superparamagnetism though the size of nanocrystal is very small. Therefore, when the nanocrystals are applicable to magnetic storage media, the ultra high areal density can be achieved.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A nano-scale spinel formed by self-assembly, the nano-scale spinel comprising:
a first phase of spinel comprising a high concentration of Jahn-Teller ions; and
a second phase of spinel comprising a low concentration of Jahn-Teller ions.

2. The spinel of claim 1, wherein the second phase of spinel is ferrimagnetic.

3. The spinel of claim 1, wherein the second phase of spinel is magnetic and the first phase is substantially non-magnetic.

4. The spinel of claim 1, wherein the spinel comprises ZnMnₓGa₂₋ₓO₄.

5. The spinel of claim 1, wherein the spinel comprises MgMnₓFe₂₋ₓO₄.

6. The spinel of claim 1, wherein the spinel comprises Co_{3-x-y}MnₓFe_{y}O₄.

7. The spinel of claim 1, wherein the first and second phases form an array of alternating substantially, non-magnetic and magnetic nanocrystals.

8. A high density storage device comprising:
a nano-scale spinel formed by self-assembly, the nano-scale spinel comprising:
a first phase of spinel comprising a high concentration of Jahn-Teller ions; and
a second phase of spinel comprising a low concentration of Jahn-Teller ions.

9. The device of claim 8, wherein the second phase of spinel is ferrimagnetic.

10. The device of claim 8, wherein the second phase of spinel is magnetic and the first phase is substantially non-magnetic.

11. The device of claim 8, wherein the spinel comprises ZnMnₓGa₂₋ₓO₄.

12. The device of claim 8, wherein the spinel comprises MgMnₓFe₂₋ₓO₄.

13. The device of claim 8, wherein the spinel comprises Co_{3-x-y}MnₓFe_{y}O₄.

14. The device of claim 8, wherein the first and second phases form an array of alternating substantially, non-magnetic and magnetic nanocrystals.

15. A method of making a self-assembled spinel having an ordered nanocrystal superlattice, the method comprising the steps of:
providing an oxide mixture that is capable of forming a spinel having Jahn-Teller ions;
sintering or heat-treating the mixture to form the spinel having the Jahn-Teller ions; and
cooling the spinel having the Jahn-Teller ions at a rate of less than 400° C./hour.

16. The method of claim 15, wherein the oxide mixture comprises at least two oxides selected from the group consisting of zinc oxides, manganese oxides, gallium oxides, magnesium oxides, cobalt oxides, iron oxides, and copper oxides.

17. The method of claim 15, wherein the spinel comprises a first phase of spinel comprising a high concentration of Jahn-Teller ions; and a second phase of spinel comprising a low concentration of Jahn-Teller ions.

18. The method of claim 17, wherein the second phase of spinel is ferrimagnetic.

19. The method of claim 17, wherein the second phase of spinel is magnetic and the first phase is substantially non-magnetic.

20. The method of claim 17, wherein the spinel comprises ZnMnₓGa₂₋ₓO₄.

21. The method of claim 17, wherein the spinel comprises MgMnₓFe₂₋ₓO₄.

22. The method of claim 17, wherein the spinel comprises Co_{3-x-y}MnₓFe_{y}O₄.

23. The method of claim 17, wherein the first and second phases form an array of alternating substantially, non-magnetic and magnetic nanocrystals.
